(19) United States
(12) Patent Application Publication
(10) Pub. No.: US 2012/0090464 A1
(43) Pub. Date: Apr. 19, 2012

(54) Capturing Carbon Dioxide From High Pressure Streams

(76) Inventor: Rodney J. Allam, Chippenham (GB)

(21) Appl. No.: 13/272,001

(22) Filed: Oct. 12, 2011

Related U.S. Application Data
(60) Provisional application No. 61/392,295, filed on Oct. 12, 2010.

(51) Int. Cl. B01D 19/00; B01D 53/22; B01D 53/14

(52) U.S. Cl. 95/42; 95/39; 96/181; 96/6

(57) ABSTRACT

The process consists of a combination of a low temperature CO2 condensation separation step followed by either a physical or chemical solvent scrubbing process. The first step results in the partial pressure of CO2 in the gaseous steam being reduced to a value near the triple point pressure of CO2. Typically, the partial pressure of CO2 is reduced to the range 5.5 bar to 7.0 bar. The second stage process then removes the remaining CO2.

### PRIORITY CLAIM OF PRIORITY

This application claims priority under 35 USC §119(e) to U.S. Patent Application Ser. No. 61/392,295, filed on Oct. 12, 2010, the entire contents of which are hereby incorporated by reference.

### TECHNICAL FIELD

This invention relates to syngas and, more particularly, to capturing carbon dioxide from high pressure streams.

### BACKGROUND

The removal of carbon dioxide from high pressure gas streams is an important unit operation in industrial processes such as ammonia production, conversion of natural gas to hydrocarbon liquids using the Fischer-Tropsch process, integrated gasification combined cycle electricity production from fossil or hydrocarbon fuels with CO₂ capture, and high pressure hydrogen production from fossil fuels.

The CO₂ can be separated from other gaseous components using processes such as absorption in a physical solvent in the Selexol or Rectisol processes, absorption in a chemical solvent such as MEA, adsorption on a solid adsorbent followed by either pressure swing or higher temperature desorption in a cyclic process; separation of CO₂ by diffusion through a membrane, and cooling the gaseous mixture to separate a liquid CO2 stream at temperatures down to the triple point temperature of CO₂.

It is the objective of this improvement to reduce the total capital and operating cost of CO₂ removal from high pressure gas streams particularly when the CO₂ partial pressure is above 8 to 10 bars and the CO₂ removed must be compressed to a high pressure for use.

### SUMMARY

The process of CO₂ removal from a gas stream containing a high partial pressure of CO₂ involves treatment of the gas stream using a combination of a low temperature CO₂ condensation separation step followed by either a physical or chemical solvent scrubbing process. The first step results in the partial pressure of CO₂ in the gaseous stream being reduced to a value near the triple point pressure of CO₂. Typically, the partial pressure of CO₂ is reduced to the range 5.5 bar to 7.0 bars. The second stage process then removes the remaining CO₂.

The method is particularly useful when the CO₂ partial pressure in the feed is above 8 to 10 bar. The advantages of this process may include one or more of the following: (1) The CO₂ stream separated from the first stage is available at a pressure of approximately 5 bar reducing the recompression energy required when the CO₂ must be produced at elevated pressure for example for introduction into a CO₂ pipeline for sequestration; (2) Recompression power for the total CO₂ removed in the two stages is significantly lower than any single stage process; and (3) A significant fraction of CH₄ or higher hydrocarbons present in the feed stream is removed with the liquid CO₂ which is condensed and separated from the bulk gas stream in a separator at a temperature close to the CO₂ triple point temperature. This would normally be a significant disadvantage in many applications since it would result in valuable fuel components being lost with the separated CO₂ stream. The Fischer-Tropsch process uses a CO+H2 synthesis gas in a catalytic system to produce hydrocarbons. Leaving the FT reactors and following liquid hydrocarbon and LPG recovery there is a substantial quantity of unconverted syn-gas plus CH4 and small quantities of higher molecular weight hydrocarbons together with inert CO2 produced with the syn-gas feed. This off-gas must be treated to remove excess CO2 so that the remaining valuable components can then be recycled to the syn-gas production unit. A significant proportion of the CO2 must be recycled to the syn-gas production system where it mixes with the feed natural gas to give the required CO to H2 ratio in the FT syn-gas feed stream. The presence of hydrocarbons in this CO2 stream is no problem in this case. The excess CO2 is then separated in the second stage CO2 removal unit and removed from the system. (4) The gaseous CO2 depleted stream leaving the first stage unit is below ambient temperature due to the finite temperature difference of 15° F. to 50° F. at the warm end of the feed/product heat exchanger. The lower temperature favors combination with a physical solvent absorption system such as Selexol for the second stage of CO₂ separation. (5) The use of a two stage CO2 removal system reduces the energy required for operation of the second stage CO2 removal system and also reduces the total energy required for CO2 separation compared to a single stage system.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram illustrating a two-staged process for capturing carbon dioxide.

Like reference symbols in the various drawings indicate like elements.

### DETAILED DESCRIPTION

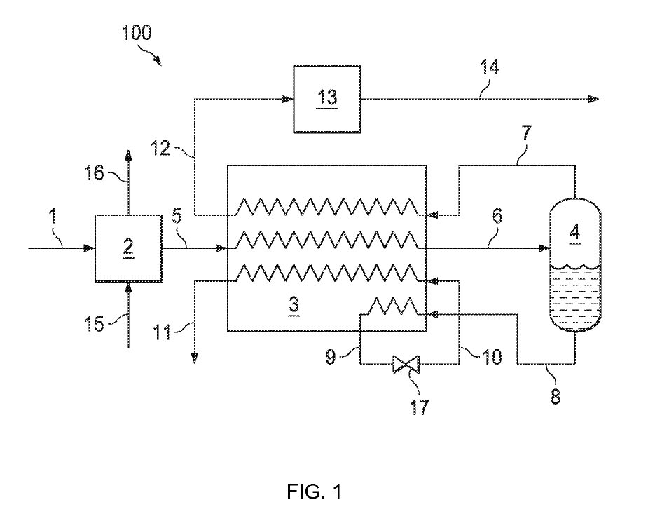

FIG. 1 illustrates a separation system 100 for removing CO₂ from a high pressure stream. For example, the system 100 may comprise a plurality of different possible separation processes to remove CO₂ from a high pressure stream. Separation process may include a condensation separation step, a physical solvent scrubbing process, a chemical solvent scrubbing process, and/or others. In some implementations, the system 100 can include a combination of a low temperature CO₂ condensation separation step followed by either a physical or chemical solvent scrubbing process. In some instances, the first step may results in the partial pressure of CO₂ in the gaseous steam being reduced to a value at least proximate the triple point pressure of CO₂ (e.g., range from about 5.5 bar to about 7.0 bar). The second stage process may then remove substantially all of the remaining CO₂.

In some implementations, the system 100 includes a condensation separator 4 and a solvent scrubbing unit 13 for removing CO₂ from a high-pressure feed stream. The elements illustrated in FIG. 1 are for illustration purposes only and the system 100 may include some, all or none without departing from the disclosure. A feed gas 1 at about 41 bars containing approximately 26.1% (molar) CO₂ is dried to a dew-point of minus 80° F. in a duel bed adsorptive temperature swing drier system 2 that is regenerated with dry nitrogen 15 to 16. The dried feed gas stream 5 is cooled using an aluminium plate fin heat exchanger 3 to a temperature of about −64.7° F. 6 at which point the partial pressure of CO₂ is approximately 5.86 bar and approximately 0.136 mols of CO₂ have condensed per mol of feed gas. The remaining vapor 7 includes about 0.125 mols CO₂ /mol feed gas still present in the vapour phase. Vapour 7 leaving the separator 4 is warmed in the heat exchanger 3 and exits as stream 12 which enters a Selexol CO₂ removal unit 13. The gaseous mixture is further purified to below 0.25% CO₂ and exits the Selexol unit as stream 14. The liquid CO₂ stream 8 leaving the separator 4 is warmed in heat exchanger 3 to a temperature of about −55° F. leaving the heat exchanger as stream 9 at about 40.2 bar. The stream 9 is then reduced in pressure to about 5.52 bar in valve 17, and the stream 10 then enters the cold end of the heat exchanger where the liquid CO₂ stream is evaporated and superheated. The separated CO₂ stream at about 5.25 bar leaves the heat exchanger as stream 11 at a temperature difference compared to the feed stream 5 of about 30° F. The superheating of stream 8 prior to pressure reduction may eliminate, minimize or otherwise reduce solid CO2 formed across the valve 17. A substantial fraction of any CH₄ present in stream 1 is dissolved in and removed by stream 8.

A number of embodiments of the invention have been described. Nevertheless, it will be understood that various modifications may be made without departing from the spirit and scope of the invention. Accordingly, other embodiments are within the scope of the following claims.

What is claimed:

1. A method for removing CO₂ from a high-pressure feed stream for a chemical process, comprising:
cooling the high-pressure feed gas stream to a temperature at least proximate to a freezing temperature of the high-pressure feed stream;
separating, from the cooled high-pressure feed stream, a condensed liquid CO₂ stream that includes at least a portion of hydrocarbon components from the high-pressure feed stream to produce a depleted-CO₂ high-pressure stream; and
removing, the depeleted-CO₂ high-pressure stream, substantially all remaining CO₂ in the cooled gas stream using at least one of a physical solvent scrubbing, a chemical solvent scrubbing, an adsorption separation, or a membrane separation.

2. The method of claim 1, wherein the high-pressure feed stream has partial pressure of CO₂ of at least 8 bars.

3. The method of claim 1, further comprising transferring heat between the high-pressure feed stream and both condensed liquid CO₂ stream and the depleted-CO₂ high-pressure stream.

4. The method of claim 1, wherein the high-pressure feed stream includes a mixture of CO+H₂.

5. The method of claim 1, wherein the high-pressure feed stream is at least a portion of a gas stream from a Fischer-Tropsch hydrocarbon synthesis system.

6. The method of claim 1, wherein the depleted-CO₂ high-pressure stream includes a partial pressure of CO₂ in a range of about 5.5 to about 7 bars.

7. A system for removing CO₂ from a high-pressure feed stream for a chemical process, comprising:
a first stage unit configured to cool the high-pressure feed gas stream to a temperature at least proximate to a freezing temperature of the high-pressure feed stream and separate, from the cooled high-pressure feed stream, a condensed liquid CO₂ stream that includes at least a portion of hydrocarbon components from the high-pressure feed stream to produce a depleted-CO₂ high-pressure stream; and
a second stage unit configured to remove, the depeleted-CO₂ high-pressure stream, substantially all remaining CO₂ in the cooled gas stream using at least one of a physical solvent scrubbing, a chemical solvent scrubbing, an adsorption separation, or a membrane separation.

8. The system of claim 7, wherein the high-pressure feed stream has partial pressure of CO₂ of at least 8 bars.

9. The system of claim 7, further comprising a heat exchanger configured to transfer heat between the high-pressure feed stream and both condensed liquid CO₂ stream and the depleted-CO₂ high-pressure stream.

10. The system of claim 7, wherein the high-pressure feed stream includes a mixture of CO+H₂.

11. The system of claim 7, wherein the high-pressure feed stream is at least a portion of a gas stream from a Fischer-Tropsch hydrocarbon synthesis system.

12. The system of claim 7, wherein the depleted-CO₂ high-pressure stream includes a partial pressure of CO₂ in a range of about 5.5 to about 7 bars.
